(19) United States
(12) Patent Application Publication
(10) Pub. No.: US 2015/0248678 A1
(43) Pub. Date: Sep. 3, 2015

(54) Product Authentication

(71) Applicant: Things3D Limited, Cheshire (GB)

(72) Inventors: Joseph Ying Sen Wee, Cheshire (GB); Christopher Ian Byatte, Cheshire (GB); Anthony David George Rhoades, Cheshire (GB); David Leslie McNeight, Cheshire (GB)

(73) Assignee: Things3D Limited, Cheshire (GB)

(21) Appl. No.: 14/250,533

(22) Filed: Apr. 11, 2014

(30) Foreign Application Priority Data
Feb. 28, 2014 (GB) 1403618.0
Mar. 14, 2014 (GB) 1404646.0

(51) Int. Cl. G06Q 30/00

(52) U.S. Cl. CPC G06Q 30/0185

(57) ABSTRACT

A method for authenticating proprietary 3D printing products comprising assigning an ID to each item printed and incorporating said ID as a component in the printing operation. ID labelling may be readable by or into a smartphone or like portable device programmed to report a reading event to a registry at which an event chain for that product is maintained.

### FIELD OF THE INVENTION

This invention relates to authenticating products, in particular products that can be manufactured in more than one place and outwith the immediate control of a proprietor of rights in regard thereto, and products that are manufactured using additive manufacturing methods or 3D printing.

### BACKGROUND

Many products, generally high value products, such as watches, or moderate value, high sales products, such as clothing, whisky and vodka, golf clubs, vehicle spare parts, medical products such as artificial hip joints, and bank notes, are counterfeited. Anticounterfeiting measures usually involve security labelling, which may comprise difficult to replicate markings such as a hologram or the incorporation of DNA having a unique sequence.

This is relatively easy to do when the products are made in one factory or at least a number of factories under common control.

However, with technological advances in 3D printing that mean valuable products can be made, and the increasingly widespread use of 3D printers, the trend is to license the right to create one or a small number of particular products made according to a design incorporated in a media file adapted to control the 3D printer.

The question arises as to how the licensor is to ensure that products are not made outwith the terms of the licence. This can happen through overproduction by the licensee, by third party access to the media file, or by reverse engineering from a product made under licence.

It has been proposed to control or monitor production, both in 2D and 3D printing.

US2013235412 discloses dividing the media file into two parts, used consecutively, in which the first part must be deleted before the second part can be run. This means that licences cannot be granted otherwise than for the production of a single product. U.S. Pat. No. 7,872,772, concerned in any event only with 2D printing, prevents a user in a printer network from accessing a print file unless specifically authorised.

No method has to date been proposed that would impact on the production of a copy of a 3D printed product by reverse engineering.

### SUMMARY OF THE INVENTION

The invention provides a method for authenticating proprietary 3D printing products that provides substantially better control over the unauthorised production of such products.

The invention comprises a method for authenticating proprietary 3D printing products comprising assigning an ID to each item printed and incorporating said ID as a component in the printing operation.

IDs will be incorporated only into authorised products. A product that does not comprise an ID or has an incorrect ID will be regarded as unauthorised and counterfeit, possibly infringing patent, design or copyright.

The ID may take many forms. It may, for example, comprise a security label which is incorporated in the product during the printing operation, and may comprise any of the commercially available such labels, such as one or more strings of alphanumeric characters or ASCII characters, characters in Greek, Cyrillic and/or Arabic script, runes, pictograms or any other machine-recognisable or human-recognisable characters including barcodes, QRCs, holograms and geometric shapes, including 3D shapes, which would be so located as to be visible for inspection. Exotic materials such as DNA may be incorporated on or near the surface or in test sites where they may be accessed

Or the ID may comprise a machine-readable ID such as an RFID label, which may be passive, so that it can be interrogated by a reader powering it by induction, or active, with its own power supply. Such labels may be introduced manually during the printing process. Such machine readable IDs may be concealed from view in the product, and may be arranged to respond only to a particular interrogation procedure, militating against reverse engineering or straightforward scanning and reproduction. Labels may be provided in appropriate numbers to licensees, and will themselves be difficult to copy. As, however, nothing, and in particular no security label, is impossible to copy, further security may be had by the print file halting the printing process at different points in the process for the introduction of the label, so that the mere copying of a label is not enough to guarantee the production of an undetectable copy product will depend also on the correct placement of the copy label.

The ID may comprise information in regard to the licensor, the licensee, a product name or part number, one or more dates, such as a date relevant to Design Right or copyright protection, a patent number or a Registered Design number. A licence to produce a limited number of products may involve the assignment of a unique code to each.

Where an ID is machine readable, it may also be changeable, as by writing new data into a register of an RFID chip, which may comprise the date on which the ID was read and information as to where it was at the time and the identity of the reader. Information read may be communicated to a licensor database. In this way, an ID can provide a transaction history.

The ID may be produced by the printing process. Contrasting material can be printed as an alphanumeric code a barcode, a QRC code or any other visually or machine readable, and may be printed on a single printed layer or distributed between multiple layers to constitute a 3D code, which may only make sense when viewed from a particular direction. The contrasting material may comprise material of a different colour or material which is differently responsive to electromagnetic radiation of a different wavelength outwith the optical spectrum such as infra-red, ultra-violet or microwave, and which is thus not apparent unless appropriately illuminated.

For such IDs, the printing instruction may be built into the print file, and need not even be known to the licensee. For a multiple product licence, the file may contain a counter function that changes the ID code with each print so that all products have different IDs, and, when all the permitted products have been made, renders the file inoperable. However, provision may be made for the file to be updated after payment of a licence renewal fee.

Incorporating ID into a product according to the invention facilitates tracking of a product through a supply chain and allows an authenticity check on presentation for resale. For some types of ID, e.g. holograms or other security printing, expert knowledge is often needed to verify authenticity, while for others special equipment is needed, as, for example, RFID chips or IDs revealed under ultra-violet, infra-red or microwave radiation.

However, codes such as bar codes and QRC codes may be read and verified or otherwise by a suitably-apped smartphone or tablet computer, which facilitates verification in the field, by a prospective purchaser, for example, who may read the code and submit it for verification to the licensor, all under the control of the app, and may add purchaser information again as a unique code, adding provenance at each step through a supply chain.

The invention also comprises a method for authenticating a product by applying thereto ID labelling readable by or into a smartphone or like portable device (hereafter referred to simply as ‘smartphone’) programmed to report a reading event to a registry at which an event chain for that product is maintained.

The smartphone may be programmed by loading an app, which may control the smartphone to read the ID labelling, to report the reading event to the registry, and to receive and display confirmation or otherwise of authenticity.

ID labelling of 3D printed products compatible with smartphone authentication may be effected during printing, instructions therefor being incorporated in the print file, either by introducing pre-printed labels in between layers of 3D printing or by printing characters in contrasting materials within a printed matrix. Characters may be staggered as between layers or printed perpendicular or inclined across multiple layers, so that they may perhaps only be readable by a suitably apped smartphone. Two or more ID labels, which may comprise characters from the same font (counting geometrical shapes, barcodes and other objects as belonging to a font) or from different fonts may be used in an authentication procedure, making it more difficult to copy and more difficult without the correct smartphone app to read.

An authentication procedure may be terminated when an incorrect ID is read, indicating that the product has not been authenticated, an may be counterfeit.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a view of part of an unfinished printed product with various IDs;

FIG. 2 is a cross section through part of another printed product;

FIG. 3 is a view of a finished product with multiple ID labels; and

FIG. 4 is a flow chart of an authentication procedure.

### DETAILED DESCRIPTION OF THE INVENTION

Methods for authenticating proprietary 3D printing according to the invention will now be described with reference to the accompanying drawings.

The drawings illustrate a method for authenticating a proprietary 3D printing product 11 comprising assigning an ID 12 to each item printed and incorporating said ID 12 as a component in the printing operation.

The purpose of the authentication is inter alia to authenticate products made under licence on a third party 3D printer. The print file that operates the printer to make the product may be sent in any convenient way, as, for example, on a recording medium such as a CD or on a USB stick, or downloaded over the internet. Ordinarily, a security label could be sent through the mail, but might well be a label that could be printed by the licensee, such as a barcode or a QRC code that might be printed on paper or plastic film or such other substrate as may be incorporated into the 3D printing operation.

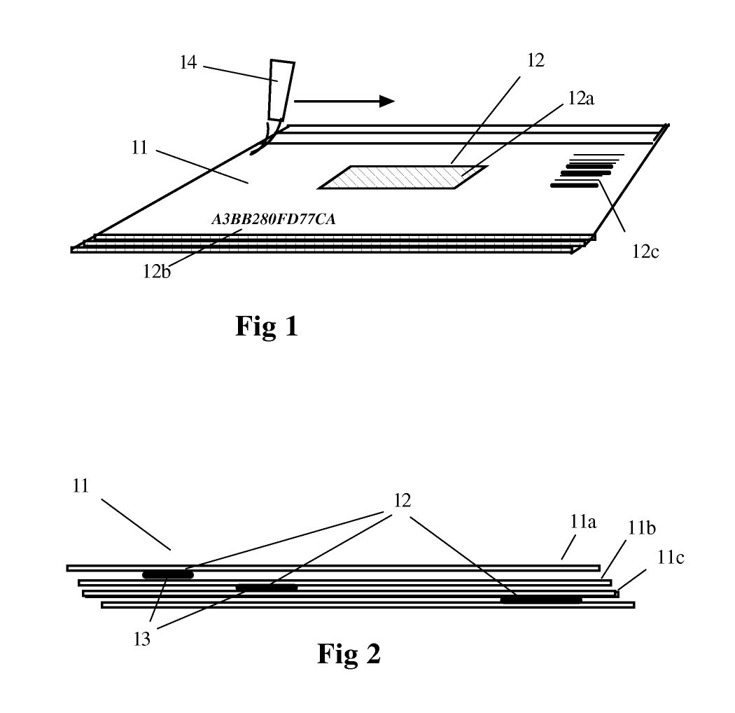

FIG. 1 illustrates an ID 12 in the form of a security label 12a which can be a complex printed label using fine printing of the kind used for banknotes, or a hologram, such as appears also on banknotes and credit and debit cards, or an RFID label that can be read by a reader that powers the RFID chip to emit a signal incorporating an ID.

FIG. 1 shows the product 11 during the printing operation, when the label 12a is physically inserted into the product as it is being laid down by the printing head 14 layer by layer, so that when printing is done the label 12a will be buried inside the product.

However, the ID may equally well be produced by the 3D printing process, and FIG. 1 illustrates an alphanumeric ID 12b made during the 3D printing operation by printing a material different from the background material, and a barcode 12c made, again, in a contrasting material. A QRC code may of course be substituted for the barcode 12c.

Depending on the nature of the material being printed and how deeply it is buried, the label will be more or less visible. Clearly, for visual inspection, the material needs to be transparent and the label not very deep. While an RFID chip can be totally concealed as it is interrogated by causing it to broadcast a radio frequency signal.

FIG. 2 illustrates distribution of the ID between different layers 11a, 11b, 11c etc of the product, a contrasting material 13 being printed in dots or lines 13 as an additional security measure. This, along with the labels 12b, 12c in FIG. 1, can be incorporated I the 3D print file for the object.

Where the 3D printing is directly under the control of the proprietor of the rights, any other ID may be used in addition to the embedded ID, such, for instance, as external labelling with smart water or even a stick-on hologram label.

Authenticating methods as disclosed herein may form the basis of 3D printed product authentication service in which a curator contracts with proprietors of intellectual property in designs for 3D printing to procure the labelling of their products.

Clearly, machine-readable labelling has advantages over other methods, particularly when, as with RFID chips, the label can be changed when the product is examined by reading new information to a register on the chip, and especially when information is passed back to a curator when the RFID chip is read, this enabling supply chain tracking and provenance trail for resale of valuable 3D printed products. RFID chips have a unique identity of their own, burnt in by the manufacturer. User added information such as an user-assigned ID code, possibly information about product origin, product design details, such as colour, weight and rights proprietor, may also be burnt in, and this information may be duplicated on a database in hardware or in the Cloud. Additional information may be added into spare registers on the RFID chip, including purchaser information.

An ideal would be for a smartphone to be able to read the ID, whether directly through its camera or other sensor or via a wired or wirelessly connected RFID reader and write to the chip with supply chain step details, reporting the same back to a central or Cloud database. However, it is possible, according to one aspect of the invention, to have like authentication even when writing to a label is not possible.

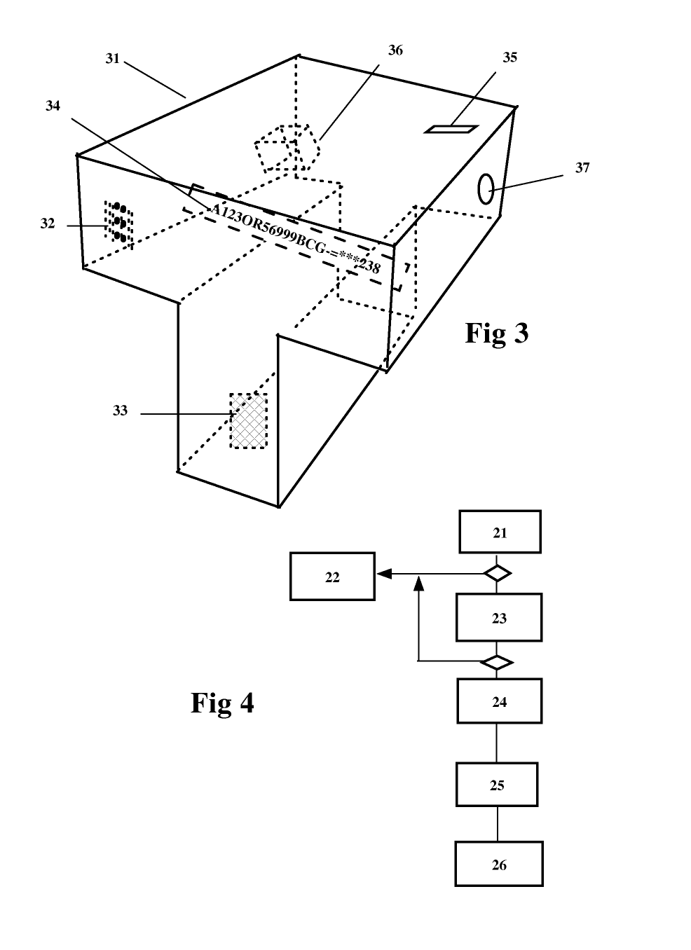

FIG. 3 illustrates a 3D printed product 31 incorporating a variety of ID labels comprising a bar code 32, a QRC 33, an alphanumeric sequence 34, an RFID chip 35, a 3D geometric formation 36, and a patch 37 of smart water or DNA or other exotic chemical impregnation.

Of these, at least the bar and QR codes 32, 33 can be read by apps available for smartphones, sequence 34 can be read by a character recognition app, the RFID chip (which might, depending on the chip, be writable to) can be read by a special app, and an app can clearly be devised to detect a geometric formation 36. Smartphones cannot yet detect DNA or other exotic chemicals, but this particular ID can be a ‘last resort’ ID when the product is sent for detailed analysis if all else fails.

The product 31 is for present purposes assumed transparent or substantially so, at least in appropriate regions, so that embedded IDs can be viewed in the optical spectrum and imaged by the camera of a smartphone. However, at least RFID chips can be read when hidden from view, and additional functionality might be incorporated in future smartphones or accessories made available that could access other ID labelling otherwise than optically. For example, an internal void might be scanned ultrasonically to detect resonance or shape.

These ID labels can be incorporated in a 3D printed product at point of production. The bar code 32, the QRC 33, the sequence 34 might be presented as printing on paper or plastic that can be inserted into the half-printed product for other layers of printing to be applied on top and seal them in. As also can the RFID chip 35. However, the IDs 32, 33 and 34 could also be printed in under the control of the print program.

A print program licensed for use on a plurality of copies can be adapted to label individual copies uniquely and to include in coding on each copies how many copies are licensed for production, after the fashion of designating prints in a limited edition as 15, 25 and so on.

Where an ID label is printed in with the printing of the product, it may be printed on a previously laid down layer as a two dimensional print, or it may be printed over multiple layers whereby to have characters on a plane extending transversely to the layering, whether at right angles or obliquely thereto. Different ID labels might be differently orientated, adding nothing or substantially nothing to the cost of printing, but adding substantially to the cost of counterfeiting.

FIG. 4 illustrates an authentication procedure.

At step 21, an appropriately apped smartphone scans a first ID label, forming a camera image of it. Software processes the image and compares it against data held within the app. If the image does not pass comparison, the app moves on to step 22, at which authenticity is denied and a report sent as an SMS or email to a registry. If the image passes comparison, at step 23 the smartphone scans a second label. Again, if the image does not pass, the program moves to step 22. If it does pass, the program moves to step 24, at which the smartphone displays a product authenticated message and moves to step 26 at which this message is conveyed to the registry, which, at step 26, updates the register for this item with details of this particular authentication event.

The smartphone can itself act as a certificate of authentication by carrying a copy of the register entry for the product in question. Only if, during an authentication procedure, the smartphone and registry register entries coincide will the product be authenticated. On a resale of the product, the ‘certificate’ can be handed over to the new custodian by transferring the app contents, under to supervision of the registry, to another smartphone.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal language of the claims.

1. A method for authenticating proprietary 3D printing products comprising:
authorizing printing of a product from a print file;
assigning an identification code (ID) to each product authorized for printing for incorporation into the printed product;
entering the ID of each product authorized for printing into a registry of IDs;
monitoring a product reading an ID of the product into a smartphone, wherein the smartphone connects to the registry of IDs to check the ID of the monitored product against the registry of IDs; and
indicating, by the smartphone, whether the ID of the monitored product and the registry IDs coincide to authenticate the monitored product.

2. A method according to claim 1, further comprising printing the product authorized for printing, wherein the assigned ID is incorporated during the printing of the product authorized for printing operation.

3.-20. (canceled)

21. A method according to claim 2, further comprising incorporating the assigned ID as an element of the printing process from data in the print file.

22. A method according to claim. 21, wherein the assigned ID includes one or more strings of machine-recognizable or human recognizable characters.

23. A method according to claim 2, wherein printing the product authorized for printing comprises printing the product authorized for printing on a third party 3D printer.

24. A method according to claim 1, wherein the assigned ID is machine readable.

25. A method according to claim 24, wherein the assigned ID is comprised of an RFID label.

26. A method according to claim 25, wherein the RFID label includes user added information.

27. A method according to claim 25, wherein monitoring the product by reading the ID of the product into a smartphone further includes writing information to the RED label.

28. A method according to claim 1, wherein the smartphone updates the registry with details of a monitoring event.

29. A method according to claim 29, wherein the smartphone carries a copy of the registry of IDs and the smartphone and registry of IDs are checked for agreement.

30. A method according to claim 1, further comprising sending the assigned ID to an approved user in response to authorizing printing of a product from a print file.
